(19) United States
(12) Patent Application Publication
(10) Pub. No.: US 2026/0278714 A1
(43) Pub. Date: Sep. 17, 2026

(54) Computerized Network System for Conducting Remote, Virtual Mediation Proceedings

(71) Applicant: BJustCoin IP Holding LLC, Sheridan, WY (US)

(72) Inventor: Beatrice T. O'Brien, Short Hills, NJ (US)

(21) Appl. No.: 19/681,469

(22) Filed: May 19, 2026

Related U.S. Application Data
(63) Continuation of application No. 17/106,694, filed on Nov. 30, 2020, now Pat. No. 12,657,640.
Application No. 17/106,694 is a continuation-in-part of application No. 16/244,720, filed on Jan. 10, 2019, now Pat. No. 11,232,403.
Application No. 16/244,720 is a continuation-in-part of application No. 16/041,070, filed on Jul. 20, 2018, now Pat. No. 10,637,900.
(60) Provisional application No. 62/668,496, filed on May 8, 2018.
(60) Provisional application No. 62/632,718, filed on Feb. 20, 2018.
(60) Provisional application No. 62/629,354, filed on Feb. 12, 2018.
(60) Provisional application No. 62/596,192, filed on Dec. 8, 2017.

(51) Int. Cl. G06Q 50/18; H04L 9/06; H04L 9/32; H04N 7/15; H04L 9/00

(52) U.S. Cl. CPC G06Q 50/182; H04L 9/0618; H04L 9/3247; H04N 7/152; H04L 9/50

(57) ABSTRACT

A computerized network system is configured to enable a mediator to conduct remote, virtual proceedings between two or more adverse parties. Each of the adverse parties participate in the proceedings through a Party App, while the mediator uses a Mediator App. A network connection connects the parties and the mediator to a system server and a system database. Virtual mediation proceedings are conducted in multiple virtual meeting rooms, and all non-private communications and documents are tracked by a blockchain process and stored in the system database.

### CROSS-REFERENCE TO RELATED APPLICATIONS

This application is a continuation of U.S. Patent Application No. 17/106,694 filed on November 30, 2020, which is a continuation-in-part of U.S. Patent Application 16/244,720 filed on January 10, 2019, which is a continuation-in-part of U.S. Patent Application 16/041,070 filed on July 20, 2018, which claims the benefit of U.S. Provisional Patent Application No. 62/596,192 filed December 8, 2017, U.S. Provisional Patent Application No. 62/629,354 filed February 12, 2018, U.S. Provisional Patent Application No. 62/632,718 filed February 20, 2018, and U.S. Provisional Patent Application No. 62/668,496 filed May 8, 2018. Each of aforementioned applications is incorporated by reference herein in its entirety.

### TECHNICAL FIELD

The present invention relates to the general field of virtual dispute resolution systems, and more particularly to virtual mediation proceedings conducted over a computerized network system.

### BACKGROUND

Mediation is a process by which legal disputes are resolved without resort to trial type evidentiary hearings. Unlike a judicial judge, a mediator does not have the power to render a binding decision on the dispute. Instead, the mediator facilitates settlement negotiations between the parties by conducting a series of conferences with the parties jointly and separately to formulate and discuss settlement proposals.

Although the application of remote video conferencing software to conduct dispute resolution is known in the prior art, there remains a need for a comprehensive network system which applies blockchain technology to generate an immutable record of virtual joint conferences, and which implements the formulation and execution of settlement agreements.

### SUMMARY

The present invention is a computerized network system for conducting a remote, virtual proceedings conducted by a mediator to resolve a dispute between two or more adverse parties. The network system comprises the network system software, which comprises a system database, a server software, a downloadable native Party App, for use by the adverse parties, a downloadable Attorney App, for use by adverse attorneys who represent the adverse parties, and a web-based Mediation App for use by the mediator in conducting the mediation proceeding. The Party App and the Attorney App both link to the Mediation App.

The network system further comprises the system hardware, which comprises party pc devices, used by the adverse parties, attorney pc devices, used by the adverse attorneys, and mediator pc devices, used by the mediator. The party pc devices run the Party App linked to the Mediation App, the attorney pc devices run the Attorney App linked to the Mediation App, and the mediator pc devices run the Mediation App.

The system server runs the server software, and the system hardware is interconnected through a network connection, which can be the internet or a cloud. The Mediation App identifies each mediation proceeding by a unique alpha-numerical case number and assigns a sequential session number to each mediation session of the mediation proceeding.

The Mediation App configures multiple virtual mediation rooms, comprising a Mediator's Room, assigned to the mediator, and multiple Party Rooms, assigned to each of the adverse parties and their adverse attorneys. The Mediation App enables the mediator to schedule the mediation session and to invite the adverse parties and their respective attorneys to participate in the mediation session, through the Party App and the Attorney App, by signing into the Mediation App through the system server, using the case number and the session number.

The Mediation App includes a video-conferencing software, which enables the mediator to conduct virtual joint conferences with the adverse parties and their attorneys in the Mediator's Room and to conduct virtual private conferences with one of the adverse parties and their attorneys in the assigned Party Room. The video-conferencing software also enables real-time sharing of multiple mediation documents between and among the adverse parties and the mediator, as well as real-time drafting and editing of the mediation documents by the adverse parties, their attorneys and/or the mediator.

The network system software is configured to implement a blockchain process, which generates an immutable record of the mediation documents and of the virtual joint conferences conducted by the mediator, and which stores the immutable record in the system database.

The Mediation App is configured to enable the mediator to elicit and receive from the adverse parties and their attorneys verbal consent authorizing the mediator to present a settlement initiative to other adverse parties. The blockchain process tracks and stores each such verbal consent in the system database. The Mediation App is also configured to enable the adverse parties to electronically sign final versions of the mediation documents and to enable electronic attestations thereof by the mediator.

In the course of one of the virtual joint conferences, the video conferencing software enables one of the participating adverse parties and their attorneys to conduct private discussions among themselves and/or with one or more other parties and/or with the mediator. These private discussions are excluded from the immutable record generated by the blockchain process. The foregoing summarizes the general design features of the present invention. In the following sections, specific embodiments of the present invention will be described in some detail. These specific embodiments are intended to demonstrate the feasibility of implementing the present invention in accordance with the general design features discussed above. Therefore, the detailed descriptions of these embodiments are offered for illustrative and exemplary purposes only, and they are not intended to limit the scope either of the foregoing summary description or of the claims which follow.

### BRIEF DESCRIPTION OF DRAWINGS

FIG. 1 is a schematic diagram of an exemplary network system, according to the illustrated embodiment of the present invention;

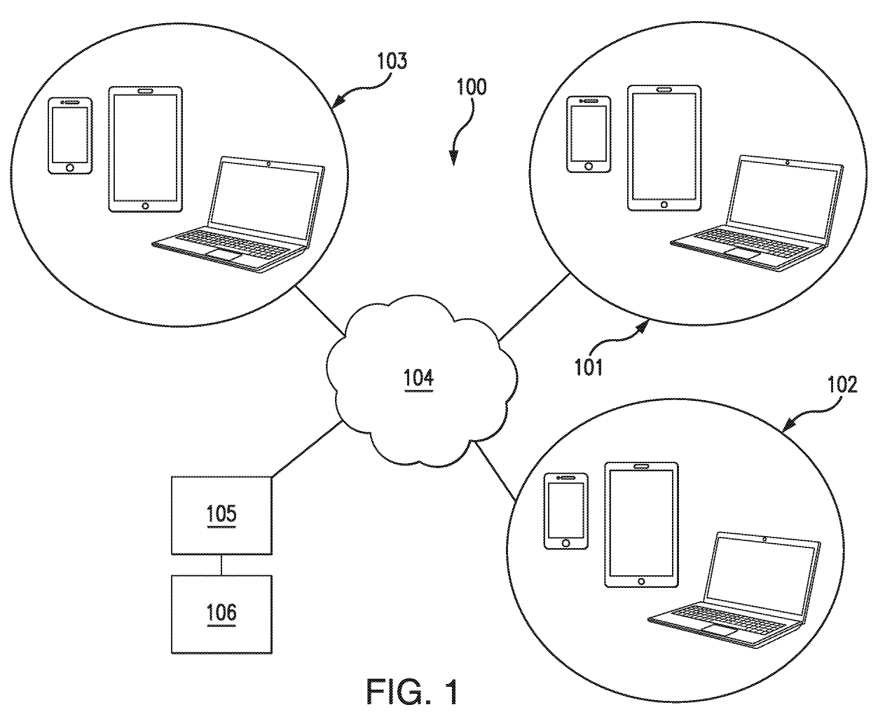

FIG. 2 is a schematic diagram of multiple exemplary virtual mediation rooms, according to the illustrated embodiment of the present invention; and

FIG. 3 is a flowchart of an exemplary remote, virtual mediation proceeding, according to the illustrated embodiment of the present invention.

### DETAILED DESCRIPTION

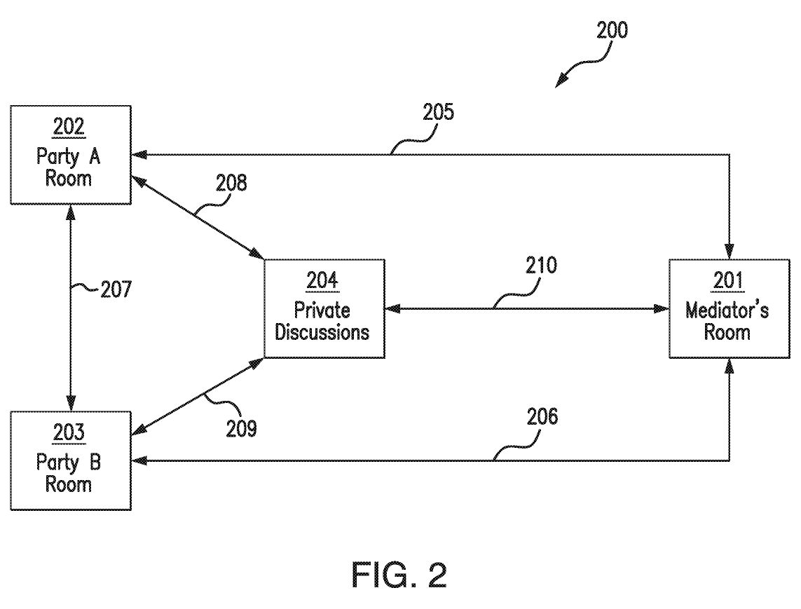

Referring to FIG. 2, the network architecture 100 for the exemplary embodiment of the present invention, in which there are two adverse parties, designated as Party A and Party B. The respective pc devices of Party A 101, Party B 102 and the mediator 103 are interconnected through a network connection 104 to the system server 105 and the system database 106. The network connection 104 can be through the internet or a cloud.

Referring to FIG. 2, an example is shown of four virtual mediation rooms 200 configured by the Mediation App. In the Mediator's Room 201, the mediator conducts the virtual joint conferences, attended by all adverse parties and their attorneys. In this exemplary configuration 200, Party A 202 and Party B 203 participate in joint conferences through their respective links 205 206 to the Mediator's Room 201.

In Party A Room 202, the mediator conducts virtual private conferences with Party A through the two-way link 205. In Party B Room 203, the mediator conducts virtual private conferences with Party B through the two-way link 206. Private communications between the two parties 202203 are through the two-way link between their rooms 207.

In the course of a virtual joint conference conducted by the mediator in the Mediator's Room 201, either or both of the parties 202203 and/or the mediator can conduct private discussions in the Private Discussion Room 204, through their respective two-way links 208 209210.

All joint conferences and their associated documents are tracked by the system's blockchain process and stored in the system database 106. All private conferences and private discussions are off-the-record and are not tracked by the blockchain process.

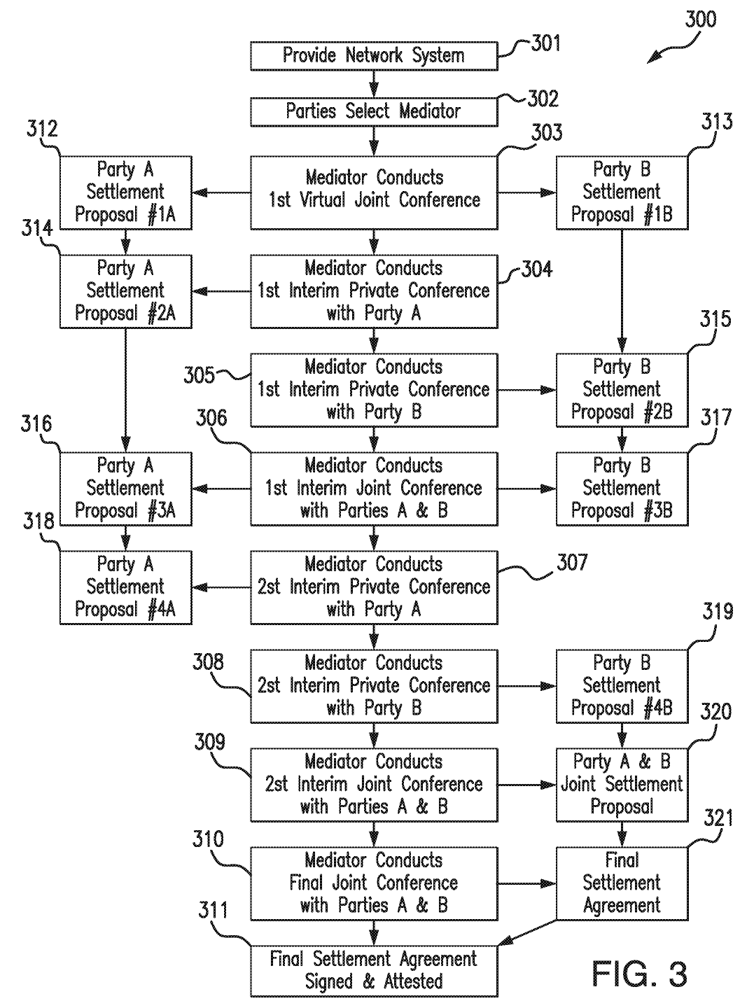

Referring to FIG. 3, the exemplary method of conducting the remote, virtual mediation proceeding 300 is illustrated. After the network is activated 301, the parties select the mediator 302, who then conducts the first virtual joint conference 303, in which Party A and Party B and their respective attorneys participate. At this initial joint conference, the parties present their initial positions regarding settlement of the dispute and each party formulates a first settlement proposal 312 313.

The mediator then conducts a first interim private conference with each of the parties 304 305, in which they discuss modifications to their respective first settlement proposals 312 313 and formulate second settlement proposals 314 315, which move closer toward an agreement. The mediator next conducts a virtual first interim joint conference 306, in which Party A and Party B and their respective attorneys participate. The parties discuss modifications to their respective second settlement proposals 314 315, and formulate third settlement proposals 316 317 which move closer toward an agreement.

The mediator then conducts a second round of interim private conferences with each of the parties 307 308, in which they discuss modifications to their respective third settlement proposals 316 317 and formulate fourth settlement proposals 318 319, which move closer toward an agreement. The mediator next conducts a virtual second interim joint conference 309, in which Party A and Party B and their respective attorneys participate. The parties discuss modifications to their respective fourth settlement proposals 318 319 and, with the guidance of the mediator, arrive at a joint settlement proposal 320, which becomes the basis of a final settlement agreement.

Finally, the mediator convenes a final joint conference 310, in which both parties and their attorneys participate. At this stage, the joint settlement proposal 320 is reduced to a final settlement agreement 321 which is signed by both parties and attested by the mediator 311.

It should be understood that, while the exemplary embodiment discussed above describes a number of rounds of virtual joint and private conferences, this number may vary from case to case, depending on the circumstances and the complexity of the dispute. It should also be understood that the various settlement proposals from each party are issued based on the consent of issuing party, and that all such consents are tracked by the system's blockchain process and stored in the system database.

Although the preferred embodiment of the present invention has been disclosed for illustrative purposes, those skilled in the art will appreciate that many additions, modifications and substitutions are possible, without departing from the scope and spirit of the present invention as defined by the accompanying claims.

1. A system for conducting a remote virtual mediation proceeding comprising:
network system software that includes: a mediation application for use by a mediator during the remote virtual mediation proceeding; a party application for use by adverse parties during the remote virtual mediation proceeding; and an attorney application for use by attorneys during the remote virtual mediation proceeding; and
one or more servers configured to execute the mediation application, the one or more servers being configured to communicate with party devices that execute the party application and attorney devices that execute the attorney application;
wherein:
the mediation application executed by the one or more servers, the party application executed by the party devices, and the attorney application executed by the attorney devices are interconnected through a network connection;
the mediation application is configured to establish multiple virtual mediation rooms comprising a virtual mediator room assigned to the mediator and multiple virtual party rooms;
the mediation application permits the mediator to establish a virtual mediation session that enables the adverse parties and adverse attorneys to participate in the virtual mediation session through the party application and the attorney application;
the network system software includes conferencing software that enables the mediator to conduct one or more virtual joint conferences with the adverse parties and their attorneys in the virtual mediator room, enables the mediator to conduct one or more virtual private conferences with one of the adverse parties and their attorneys in one of the multiple virtual party rooms, and enables private discussions to be conducted by any of the adverse parties, the attorneys, and/or the mediator;
the network system software is configured to implement a blockchain process that generates an immutable record for the remote virtual mediation proceeding while excluding private communications corresponding to the remote virtual mediation proceeding.

2. The system according to claim 1, wherein the mediation application is configured to enable the mediator to elicit and receive consent authorizations from one or more of the adverse parties and their adverse attorneys that authorize the mediator to present a settlement proposal to other adverse parties and/or their adverse attorneys.

3. The system according to claim 2, wherein the blockchain process tracks and records each consent authorization in the immutable record for the remote virtual mediation proceeding.

4. The system according to claim 1, wherein the mediation application is configured to enable the adverse parties to electronically sign final versions of mediation documents, and to enable the mediator to electronically attest electronic signatures of the adverse parties.

5. The system according to claim 1, wherein the mediation application is configured to issue a settlement proposal in response to receiving a consent authorization from one or more of the adverse parties authorizing issuance of the settlement proposal, and wherein the blockchain process is configured to track and record the settlement proposal.

6. The system according to claim 1, wherein the private discussions are conducted in a virtual private discussion room that permits off-the-record interactions to be conducted, and excluding private communications corresponding to the remote virtual mediation proceeding includes excluding the off-the-record interactions conducted in the virtual private discussion room.

7. The system according to claim 1, wherein:
the blockchain process is configured to track the one or more virtual joint conferences corresponding to the remote virtual mediation proceeding;
the blockchain process is configured to track mediation documents corresponding to the remote virtual mediation proceeding;
the blockchain process is configured to track any consent authorizations provided by the adverse parties in connection with a settlement proposal; and
the blockchain process excludes the private discussions involving any of the adverse parties, the attorneys, and/or the mediator.

8. The system according to claim 1, wherein the remote virtual mediation proceeding to resolve a dispute between the adverse parties, is configured to:
(a) enable the adverse parties to select the mediator;
(b) conduct a first virtual joint conference using the conferencing software, in which at least some of the adverse parties and adverse attorneys participate, and in which each adverse party shares an initial position document that sets forth a settlement proposal of said adverse party;
(c) use the conferencing software to enable the mediator to conduct a series of interim virtual joint conferences, in which the mediator and some or all of the adverse parties and/or the attorneys participate in discussions of modifications to at least one offered settlement proposal toward reaching a mutually acceptable settlement agreement; and
(d) use the conferencing software and the network system software to enable the mediator to conduct a final virtual joint conference, in which all of the adverse parties and the attorneys participate, and in which the mutually acceptable settlement agreement is reduced to a final settlement document, which is electronically signed by all the adverse parties and electronically attested by the mediator.

9. The system according to claim 8, wherein the blockchain process is configured to track and record the final settlement document.

10. The system according to claim 1, wherein conferencing software is configured to enable real-time sharing of a mediation document between and among the adverse parties and the mediator.

11. The system according to claim 1, wherein conferencing software is configured to enable real-time drafting and editing of a mediation document by the adverse parties, their attorneys and/or the mediator.

12. The system for conducting the remote virtual mediation proceeding according to claim 1, wherein the mediation application is configured to enable the mediator to schedule the virtual mediation session and to invite the adverse parties and the adverse attorneys to participate in the virtual mediation session.

13. The system according to claim 1, wherein the virtual mediation session is accessible to the mediator, adverse parties, and the adverse attorneys by using a unique credential identifying a case corresponding to the remote virtual mediation proceeding.

14. A computerized method implemented via computing instructions stored on one or more non-transitory storage devices and executed by one or more processing devices, the computerized method comprising:
connecting a mediation application, a party application, and an attorney application;
conducting a virtual mediation proceeding via the mediation application, wherein the mediation application is utilized by a mediator during the virtual mediation proceeding, the party application is utilized by adverse parties during the virtual mediation proceeding, and the attorney application is utilized by attorneys during the virtual mediation proceeding; and
establishing, via the mediation application, multiple virtual mediation rooms comprising a virtual mediator room assigned to the mediator and multiple virtual party rooms;
establishing, via the mediation application, a virtual mediation session that enables the adverse parties and adverse attorneys to participate in the virtual mediation session through the party application and the attorney application;
enabling, via conferencing software, the mediator to conduct one or more virtual joint conferences with the adverse parties and their attorneys in the virtual mediator room, and enabling the mediator to conduct one or more virtual private conferences with one of the adverse parties and their attorneys in one of the multiple virtual party rooms; and
implementing a blockchain process, that generates an immutable record for the remote virtual mediation proceeding while excluding private communications corresponding to the remote virtual mediation proceeding.

15. The method according to claim 14, wherein the mediation application is configured to enable the mediator to elicit and receive consent authorizations from one or more of the adverse parties and their adverse attorneys that authorize the mediator to present a settlement proposal to other adverse parties and/or their adverse attorneys, and the blockchain process tracks and records each consent authorization in the immutable record for the remote virtual mediation proceeding.

16. The method according to claim 14, wherein the conferencing software permits private discussions to be conducted in a virtual private discussion room, and excluding private communications corresponding to the remote virtual mediation proceeding includes excluding the private discussions conducted in the virtual private discussion room.

17. The method according to claim 14, wherein:
the blockchain process is configured to track the one or more virtual joint conferences corresponding to the remote virtual mediation proceeding;
the blockchain process is configured to track mediation documents corresponding to the remote virtual mediation proceeding;
the blockchain process is configured to track any consent authorizations provided by the adverse parties in connection with a settlement proposal; and
the blockchain process excludes private discussions involving any of the adverse parties, the attorneys, and/or the mediator.

18. The method according to claim 14, further comprising:
(a) enabling the adverse parties to select the mediator;
(b) conducting a first virtual joint conference using the conferencing software, in which at least some of the adverse parties and adverse attorneys participate, and in which each adverse party shares an initial position document that sets forth a settlement proposal of said adverse party;
(c) conducting, via the conferencing software, a series of interim virtual joint conferences, in which the mediator and some or all of the adverse parties and/or the attorneys participate in discussions of modifications to at least one offered settlement proposal toward reaching a mutually acceptable settlement agreement; and
(d) conducting, via the conferencing software, a final virtual joint conference, in which the adverse parties and the attorneys participate, and in which the mutually acceptable settlement agreement is reduced to a final settlement document, which is electronically signed by all the adverse parties and electronically attested by the mediator.

19. The method according to claim 18, wherein the blockchain process is configured to track and record the final settlement document.
